(19) United States
(12) Patent Application Publication
(10) Pub. No.: US 2007/0163312 A1
(43) Pub. Date: Jul. 19, 2007

(54) REINFORCED HANDLE ASSEMBLY FOR LOCK

(75) Inventor: Mu-Lin Shen, Tainan (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: I-TEK METAL MFG. CO., LTD., Annan (TW)

(21) Appl. No.: 11/306,884

(22) Filed: Jan. 13, 2006

(51) Int. Cl. E05B 13/10

(52) U.S. Cl. 70/224

(57) ABSTRACT

A lock includes a handle, a hub, a spindle rotatably mounted in the hub and coupled to the handle to turn therewith, and a transmission member fixed to the handle to turn therewith. The transmission member is stopped by the hub after the handle has been turned through an angle, transmitting a torque from the handle to the hub via the transmission member. Thus, impact from the handle can be partly transmitted to the hub and then to a door on which the lock is mounted, instead of completely transmitted to the spindle. Damage to the spindle is thus avoided.

### BACKGROUND OF THE INVENTION

1. Field of the Invention

The present invention relates to a handle assembly. More particularly, the present invention relates to a handle assembly for a lock.

2. Description of the Related Art

The outside handle of a conventional door lock could not be turned when in a locked state. However, the inner parts of the lock may be damaged after frequent turning of the outside handle in the locked state. U.S. Pat. No. 6,705,138 to the Applicant discloses a clutch mechanism for a lock in which the outside handle rotates freely when the lock is in a locked state so that damage to the inner parts of the lock is avoided.

More specifically, as illustrated in FIG. 1 of the drawings, the lock disclosed in U.S. Pat. No. 6,705,138 comprises an outside handle 31, an outside spindle 41 having an end fixed to the outside handle 31, a cam 42 received in an end of the outside spindle 41 and releasably engaged with a retractor 52 of a latch mechanism 5, a sleeve 43 received in the cam 42 and securely engaged with a locking bar 14 to turn therewith, and a lug 44 that is movable together with the cam 42 along a longitudinal direction and that is pivotally mounted around an end of the sleeve 43. When the locking bar 14 is moved inward to a locking position as a result of pushing a push button 15, the cam 42 is disengaged from the retractor 52 so that the outside handle 31 turns freely, preventing damage to the inner parts of the lock.

However, it was found that, after the outside handle 31 and the outside spindle 41 had been turned freely through a pre-determined angle (typically 45 degrees or 60 degrees), further free rotation of the outside handle 31 was stopped by a lock housing comprised of an outside hub 33 and an inside hub 13, causing an impact to the outside handle 31 and the outside spindle 41. Hence, stress concentration occurs in the coupling area between the outside handle 31 and the outside spindle 41 that is relatively weak as compared to other parts of the lock, resulting in damage to or breakage of the outside spindle 41.

More specifically, referring to FIG. 1, the outside handle 31 is coupled with the outside spindle 41 by a spring-biased engaging plate 48 that extends in a plane orthogonal to the longitudinal direction of the spindle 41. The spindle 41 includes two holes 410a and 410b. A spring 47 is mounted between the engaging plate 48 and the outside spindle 41 for biasing the engaging plate 48 to a pre-determined position, with an end of the spring 47 extending out of the outside spindle 41 via one of the holes (e.g., hole 410a), with the other hole 410b providing a space allowing inward movement of the engaging plate 48. The outside handle 31 includes a groove 311 for receiving an end of the engaging plate 48 when the outside handle 31 is mounted around the outside spindle 41, thereby positioning the outside spindle 31.

Formation of the holes 410a and 410b weakens the outside spindle 41. Namely, the weakest portion of the outside spindle 41 is the place to which the engaging plate 48 is engaged. Hence, when the lock is in the locked state and when the outside handle 31 and the outside spindle 41 have been turned through a pre-determined angle, further rotational force applied to the outside handle 31 causes damage to and breakage of the outside spindle 41 at the weakest portion.

### BRIEF SUMMARY OF THE INVENTION

An objective of the present invention is to provide a reinforced handle assembly for a lock for preventing damage to the spindle resulting from a torque applied to a handle that has been turned through a pre-determined angle.

A lock in accordance with the present invention comprises a handle, a hub, a spindle rotatably mounted in the hub and coupled to the handle to turn therewith, and a transmission member fixed to the handle to turn therewith. The transmission member is stopped by the hub after the handle has been turned through an angle, transmitting a torque from the handle to the hub via the transmission member.

Thus, impact from the handle can be partly transmitted to the hub and then to a door on which the lock is mounted, instead of completely transmitted to the spindle. Damage to the spindle is thus less likely to occur.

Preferably, the transmission member is a ring mounted around the spindle.

Preferably, the handle comprises a shank with an inner periphery including a groove, and the ring comprises a protrusion engaged with the groove of the handle.

Preferably, a stop ring is fixed in the hub and mounted around the spindle. The stop ring comprises a restraining groove delimited by two end walls. The transmission member comprises a stop that is stopped by one of the end walls delimiting the restraining groove after the handle has been turned through the angle.

Preferably, the stop ring further comprises an engaging groove in an outer periphery thereof, and the hub comprises a protrusion on an inner periphery thereof for securely coupling with the engaging groove of the stop ring.

Preferably, the lock further comprises an elastic element for returning the handle.

Preferably, the handle is an outside handle, the hub is an outside hub, and with the spindle is an outside spindle.

Other objectives, advantages, and novel features of the invention will become more apparent from the following detailed description when taken in conjunction with the accompanying drawings.

### BRIEF DESCRIPTION OF THE DRAWINGS

FIG. 1 is a sectional view of a conventional lock.

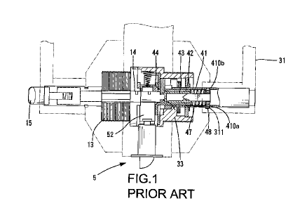

FIG. 2 is an exploded perspective view of a lock with a reinforced handle assembly in accordance with the present invention.

FIG. 3 is a sectional view of the lock in FIG. 2.

FIG. 4 is a perspective view, partly cutaway, illustrating the reinforced handle assembly in accordance with the present invention.

FIG. 5 is a sectional view taken along plane 5-5 in FIG. 3.

FIG. 6 is a sectional view taken along plane 6-6 in FIG. 3.

FIG. 7 is a view similar to FIG. 6, wherein the outside handle is stopped after turning through a pre-determined angle.

### DETAILED DESCRIPTION OF THE INVENTION

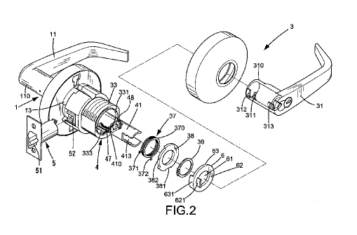

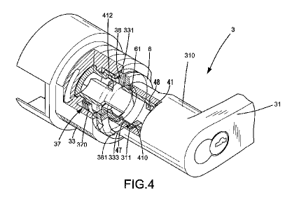

FIG. 2 illustrates a lock with a reinforced handle assembly in accordance with the present invention. Referring to FIGS. 2 through 4, the lock comprises an inside handle assembly 1, an inside spindle 2, an outside handle assembly 3, an outside transmission assembly 4, and a latch mechanism 5. The outside handle assembly 3 is reinforced as compared to conventional designs, which will be described in detail later.

The inside handle assembly 1 comprises an inside handle 11 coupled to the inside spindle 2 to turn therewith. The inside spindle 2 is mounted in an inside hub 13. The outside handle assembly 3 comprises an outside handle 31. The outside transmission assembly 4 comprises an outside spindle 41 that is coupled to the outside handle 31 to turn therewith. An inner end of the outside spindle 41 is mounted in an outside hub 33. The inside hub 13 and the outside hub 33 together form a lock housing for receiving the latch mechanism 5. The latch mechanism 5 comprises a latch bolt 51 and a retractor 52 that is operably connected to the latch bolt 51 and that is movable between a latching position and an unlatching position.

Referring to FIGS. 2 through 5, the outside transmission assembly 4 further comprises an engaging plate 48 and a spring 47 for biasing the engaging plate 48. The engaging plate 48 extends through a hole 410 in the outside spindle 41 into a groove 311 in an inner periphery of a shank 310 of the outside handle 31, thereby coupling the outside handle 31 with the outside spindle 41. The outside spindle 41 further includes a notch 413 in an end thereof for coupling with a protrusion 313 on the inner periphery of the shank 310 of the outside handle 31. Hence, when the outside handle 31 is turned, the outside spindle 41 is turned for retracting the retractor 52, which is conventional. In a case that the lock is in a locked state and the outside handle 31 has been turned through a predetermined angle (e.g., 45 degrees), further rotation of the outside handle 31 is stopped, yet damage to the outside spindle 41 at the area including the hole 410 occurs when a further rotational force is applied to the outside handle 31, as mentioned in the background of the invention.

To solve this problem, the outside handle assembly 3 is reinforced to improve the strength between the outside handle 31 and the outside spindle 41.

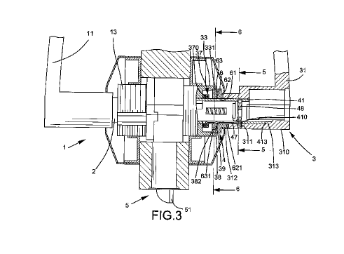

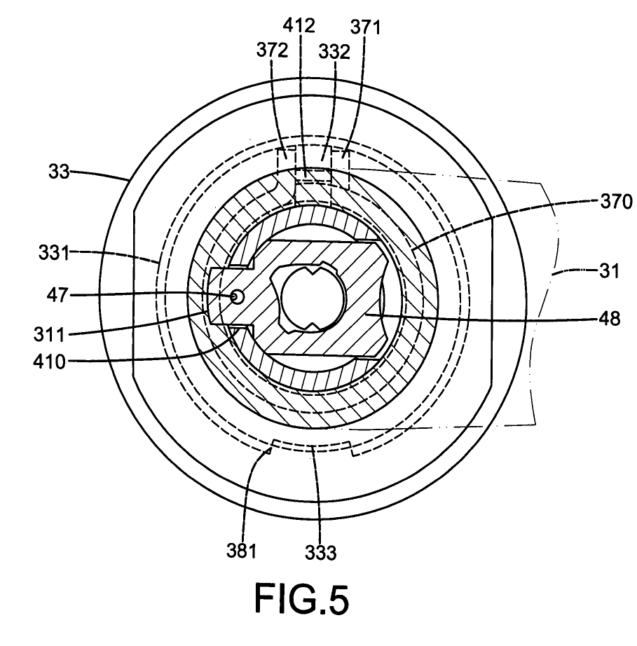

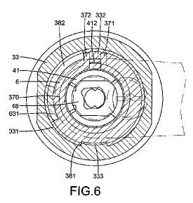

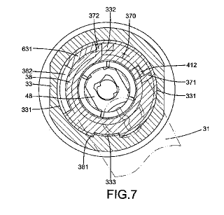

Referring to FIGS. 3 and 6, an elastic element 37 is mounted between an inner periphery of an end 331 of the inside hub 33 and an outer periphery of the outside spindle 41. The elastic element 37 in this embodiment is a torsion spring 370 having two ends 371 and 372 respectively pressing against two sides of a protrusion 332 (FIG. 5) on an inner periphery of the outside hub 33. Referring to FIG. 7, when the outside spindle 41 is turned together with the outside handle 31, one of the ends (e.g., the end 371) of the torsion spring 370 is carried by a lug 412 of the outside spindle 41, storing energy for subsequently returning the outside spindle 31 when the outside spindle 31 is released.

A stop ring 38 is mounted between the inner periphery of the end 331 of the inside hub 33 and the outer periphery of the outside spindle 41 and avoids undesired disengagement of the torsion spring 370. A retainer ring 39 is mounted around the outside spindle 41 to fix the longitudinal position of the stop ring 38. The stop ring 38 includes an engaging groove 381 in an outer periphery thereof for coupling with a protrusion 333 on the inner periphery of the outside hub 33, preventing the stop ring 38 from rotating relative to the outside hub 33. The stop ring 38 further comprises a restraining groove 382 in the outer periphery thereof, which will be described later.

A transmission member 6 is fixedly mounted to a front end of the shank 310 of the outside handle 31 to turn therewith. The transmission member 6 is substantially a ring having a longitudinal hole 61 so as to be mounted around the outside spindle 41. Further, the ring includes an inner side 63 facing the inside hub 33 and an outer side 62 facing the shank 310 of the outside handle 31, with an engaging portion 621 on the outer side 62 of the ring and with a stop 631 on the inner side 63 of the ring. In this embodiment, the engaging portion 621 is a protrusion for coupling with a groove 312 in the inner periphery of the shank 310 of the outside handle 31, allowing joint rotation of the outside handle 31 and the transmission member 6.

The stop 631 may be a protrusion projecting from the inner side 63 of the transmission member 6 and extending along the longitudinal direction of the outside spindle 41. After assembly, the transmission member 6 is mounted around the outside spindle 41 (FIG. 3), with the stop 631 received in the restraining groove 382 of the stop ring 38. The stop 631 is movable in the restraining groove 382 until it is stopped by one of two end walls delimiting the restraining groove 382. Thus, the stop 631 may move through a predetermined angle (e.g., 45 degrees or 60 degrees), which is the pre-determined rotational angle of the outside handle 31.

When either handle (e.g., the outside handle 31) is turned, the outside spindle 41 and the transmission member 6 are also turned until the stop 631 of the transmission member 6 is stopped by one of the end walls delimiting the restraining groove 382 of the stop ring 38 that is fixed on the outside hub 33, as shown in FIG. 7. When the outside handle 31 is released, the outside handle 31 and the outside spindle 41 as well as the transmission member 6 are returned to a position shown in FIG. 6.

In a case that the lock is in a locked state and a rotational force in the same direction is applied to the outside spindle 31 after the outside spindle 31 has been turned freely through the pre-determined angle to a position shown in FIG. 7, since the stop 631 of the transmission member 6 is stopped by one of the end walls delimiting the restraining groove 382 of the stop ring 38 that is fixed on the outside hub 33, the torque applied to the outside handle 31 can be imparted to the outside hub 33 via the transmission member 6. Thus, impact from the outside handle 31 can be partly transmitted to the outside hub 33 and then to the door on which the lock is mounted, instead of completely transmitted to the outside spindle 41. Damage to the outside spindle 41 is thus less likely to occur. Arrangement allowing free rotation of the outside handle 31 in a locked state is conventional and therefore not described in detail.

The stop 631 of the transmission member 6 can be restrained by the outside hub 33 via another arrangement other than the stop ring 38. Nevertheless, use of the stop ring 38 may cut the cost, as most of the elements of the lock can still be used without modification. In an alternative arrangement, the stop ring 38 may be omitted, and the stop 631 of the transmission member 6 is directly stopped by the outside hub 33.

The reinforced handle assembly in the illustrated embodiment is the outside handle assembly. In an alternative example, the reinforced handle assembly is the inside handle assembly. In this case, the transmission member 6 is fixed to a shank 110 of the inside handle 11 to turn therewith, and the impact from the inside handle 11 can be imparted to the inside hub 33 to avoid damage to the inside spindle 2. In another alternative example, the lock may comprises a reinforced inside handle assembly and a reinforced outside handle assembly.

Although specific embodiments have been illustrated and described, numerous modifications and variations are still possible without departing from the essence of the invention. The scope of the invention is limited by the accompanying claims.

1. A lock comprising:
a handle;
a hub;
a spindle rotatably mounted in the hub and coupled to the handle to turn therewith;
a stop ring fixed in the hub and mounted around the spindle, the stop ring including a restraining groove delimited by two end walls; and
a transmission member fixed to the handle to turn therewith, with the transmission member being mounted around the spindle and not rotatably fixed thereto, with the transmission member including a stop movably engaged in the restraining groove, the stop being stopped by one of the end walls delimiting the restraining groove after the handle has been turned freely through an angle by a rotational force when the lock is in a locked state;
wherein when a torque is applied to the handle that has been turned freely through the angle, the torque is imparted to the hub via the transmission member preventing the spindle from being damaged by the torque.

2. The lock as claimed in claim 1, with the transmission member being a ring mounted around the spindle.

3. (canceled)

4. The lock as claimed in claim 1, with the stop ring further comprising an engaging groove in an outer periphery thereof, and with the hub comprising a protrusion on an inner periphery thereof for securely coupling with the engaging groove of the stop ring, with the restraining groove being formed on the outer periphery of the stop ring circumferentially spaced from and at equal radial spacing as the engaging groove.

5. The lock as claimed in claim 2, with the handle comprising a shank with an inner periphery including a groove, and with the ring comprising a protrusion engaged with the groove of the handle.

6. The lock as claimed in claim 1, with the lock further comprising an elastic element for returning the handle.

7. (canceled)

8. The lock as claimed in claim 6, with the stop ring further comprising an engaging groove in an outer periphery thereof, and with the hub comprising a protrusion on an inner periphery thereof for securely coupling with the engaging groove of the stop ring, with the restraining groove being formed on the outer periphery of the stop ring circumferentially spaced from and at equal radial spacing as the engaging groove.

9. The lock as claimed in claim 1, with the handle being an outside handle, with the hub being an outside hub, and with the spindle being an outside spindle.
